(19) United States
(12) Patent Application Publication
(10) Pub. No.: US 2016/0001707 A1
(43) Pub. Date: Jan. 7, 2016

(54) HINGED SERVICE STEP FOR LARGE WHEELED LOADERS

(71) Applicant: Caterpillar Inc., Peoria, IL (US)

(72) Inventors: Robert J. Madera, Lemont, IL (US); John M. Teter, North Aurora, IL (US)

(21) Appl. No.: 14/321,930

(22) Filed: Jul. 2, 2014

(51) Int. Cl. B60R 3/00; B23K 31/02; E02F 9/08; B23P 11/00

(52) U.S. Cl. CPC B60R 3/005; B23P 11/00; B23K 31/02; E02F 9/0833; B23P 2700/50

(57) ABSTRACT

A hinged service step assembly including a first tread plate and a second tread plate connected to the first tread plate with a hinge. The hinged service step further including an attachment bracket connected to the second tread plate machine. The attachment bracket attaching to a machine having a lift arm.

### TECHNICAL FIELD

The present disclosure generally relates to service steps, and more particularly relates to a hinged service step assembly that provides improved access to portions of a machine having a lift arm.

### BACKGROUND

A wheel loader is a heavy construction machine used for moving material from one place to another at a worksite. The wheel loader includes a body portion housing an engine and having rear wheels driven by the engine. The body portion also includes an elevated cab for an operator having windshields. A non-engine front frame portion having front wheels is attached to the body portion by an articulated connection allowing the end frame to pivot from side-to-side when the front wheels are turned to steer the machine. The front frame further includes linkages, such as Z-bar linkages, lift arms, and lift cylinders for manipulating a bucket or forks. The lift cylinders raise and lower the pair of lift arms to adjust the elevation of the lift arms above the ground.

During operation, an operator may need to access or clean outside portions of the windshield. Often, operators lower the lift arms to ground the bucket or forks before proceeding to step on a top portion of the lift arms to access the outside portions of the windshield. However, the operator often has a difficult time identifying a stable stepping surface. Apparatuses for assisting the operator in accessing portions of large machines, such as wheel loaders, have proved ineffective. Typically, such apparatuses fail to provide the lift arms with a full range of motion. For example, U.S. Patent Publication No. 2009/0008895 discloses a power driven access step that is capable of being moved between an operating lower position and a raised stowage position. The step is carried by a telescopically collapsible tubular strut and an actuator is housed within the strut for raising and lowering the step by extending and contracting the strut.

The foregoing background discussion is intended solely to aid the reader. It is not intended to limit the innovations described herein, nor to limit or expand the prior art discussed. Consequently, the foregoing discussion should not be taken to indicate that any particular element of a prior system is unsuitable for use with the innovations described herein, nor is it intended to indicate that any element is essential in implementing the innovations described herein. The implementations and application of the innovations described in the disclosure are defined by the appended claims.

### SUMMARY

In one aspect, the present disclosure provides a hinged service step assembly including a first tread plate and a second tread plate connected to the first tread plate with a hinge. The hinged service step assembly further includes an attachment bracket connected to the second tread plate machine. The attachment bracket attaches to a machine having a lift arm.

In another aspect, the present disclosure provides a hinged service step assembly including a first tread plate having a midsection, a first side portion extending away from the midsection, and a second side portion extending away from the midsection in the same direction as the first side portion. The hinged service step assembly also includes a second tread plate connected to the first tread plate with a hinge and an attachment bracket connected to the second tread plate machine. The attachment bracket attaches to a wheel loader.

In yet another aspect, the present disclosure provides a method for retrofitting a machine having a lift arm with a hinged service step assembly including attaching the hinged service step assembly to the lift arm. The hinged service step assembly including a first tread plate and a second tread plate connected to the first tread plate with a hinge. The hinged service step assembly further includes an attachment bracket connected to the second tread plate machine. The attachment bracket attaches to a machine having a lift arm.

Other features and aspects of this disclosure will be apparent from the following description and the accompanying drawings.

### BRIEF DESCRIPTION OF THE DRAWINGS

FIG. 1 is a schematic side view of a wheel loader within which one or more embodiments of the present disclosure may be implemented;

FIG. 1a is a schematic view of a hinged service step assembly attached to a front portion of a wheel loader;

FIG. 2 is a schematic view of a hinged service step assembly in isolation;

FIG. 3 is a schematic view of a wheel loader having lift arms in first, second, and grounded positions within which one or more embodiments of the present disclosure may be implemented;

FIG. 3a is a schematic view of a hinged service step assembly attached to a front portion of a wheel loader having lift arms in a first raised positioned;

FIG. 3b is a schematic view of a hinged service step assembly attached to a front portion of a wheel loader having lift arms in a second raised positioned; and

FIG. 3c is a schematic view of a hinged service step assembly attached to a front portion of a wheel loader having lift arms in a grounded positioned.

While the disclosure is susceptible to various modifications and alternative forms, specifics have been shown by way of example in the drawings and will be described in detail below. It should be understood that the detailed description is not to limit aspects of the disclosure to the particular embodiments described. On the contrary, the disclosure covers all modifications, equivalents, and alternatives falling within the spirit and scope of the disclosure.

### DETAILED DESCRIPTION

The present disclosure relates to a hinged service step assembly that helps provide operator access to portions of machines having lift arms such as a wheel loader. Wherever possible the same reference numbers will be used throughout the drawings to refer to the same or like parts. Moreover, references to various elements described herein are made collectively or individually when there may be more than one element of the same type. However, such references are merely exemplary in nature. Accordingly, it may be noted that any such reference to elements in the singular is also to be construed to relate to the plural and vice-versa without limiting the scope of the disclosure to the exact number or type of such elements unless set forth explicitly in the appended claims.

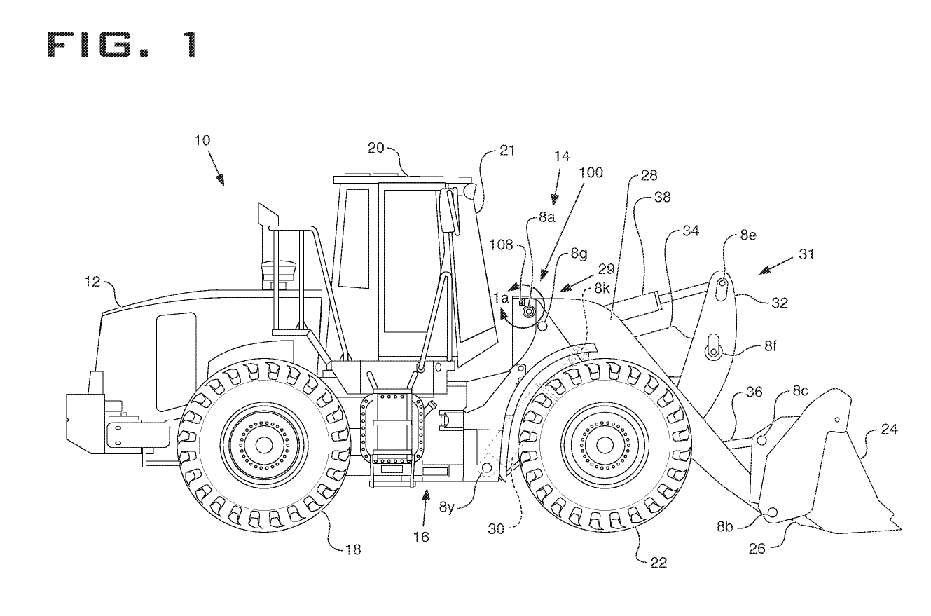

FIG. 1 shows an exemplary machine 10 within which one or more embodiments of the present disclosure may be implemented. Machine 10 may be a wheel loader 10 configured to load, transport, and unload material. The wheel loader 10 includes a body portion 12 and a non-engine front frame 14 connected by an articulating joint 16. The body portion 12 houses an engine that drives rear wheels 18, and includes an elevated cab 20 for an operator. Elevated cab 20 includes windshield portion 21. The front frame 14 has front wheels 22 that are turned by a steering mechanism. The articulating joint 16 allows the front frame 14 to move from side-to-side to turn the wheel loader 10. In the illustrated embodiment, a bucket 24 is mounted to the front frame 14 with coupler 26.

The bucket 24 and coupler 26 may be configured for secure attachment of the bucket 24 during use of the wheel loader 10, and for release of the bucket 24 and substitution of other apparatuses such as a fork lift (not shown). Coupler 26 is connected to the front frame 14 by a pair of lift arms 28. One end of each lift arm 28 is pivotally connected to the front frame 14 and the other end is pivotally connected to the coupler 26. Hinged service step assembly 100 is connected to the front frame 14 by attachment brackets 108 near the top portion 29 of lift arms 28. As shown in FIG. 1a, hinged service step assembly 100 includes a first tread plate 102 and a second tread plate 104 having hinge 106. As will be discussed in more detail below, first tread plate 102 moves with lift arms 28 during operation of wheel loader 10.

The lift arms 28 rotate about the point of connection to the front frame 14. Corresponding lift cylinder 30 controls the rotation of the lift arms 28. The lift cylinder 30 pivotally couples to the front frame 14 and the lift arms 28. The lift cylinder 30 is capable of extending to raise the lift arms 28 and retracting to lower the lift arms 28. Z-bar linkage assembly 31 is operatively associated with front frame 14. Z-bar linkage assembly 31 is capable of controlling the rotation of coupler 26 and bucket 24. The Z-bar linkage assembly 31 may include a tilt lever 32 pivotally connected to a tilt lever support 34 mounted to the lift arms 28 such that the tilt lever support 34 moves with lift arms 28. At one end of the tilt lever 32, a tilt link 36 has one end pivotally connected to the end of the tilt lever 32, and the opposite end pivotally connected to the coupler 26 proximate the top. A tilt cylinder 38 couples the opposite end of the tilt lever 32 to the front frame 14 with pivotal connections at either end.

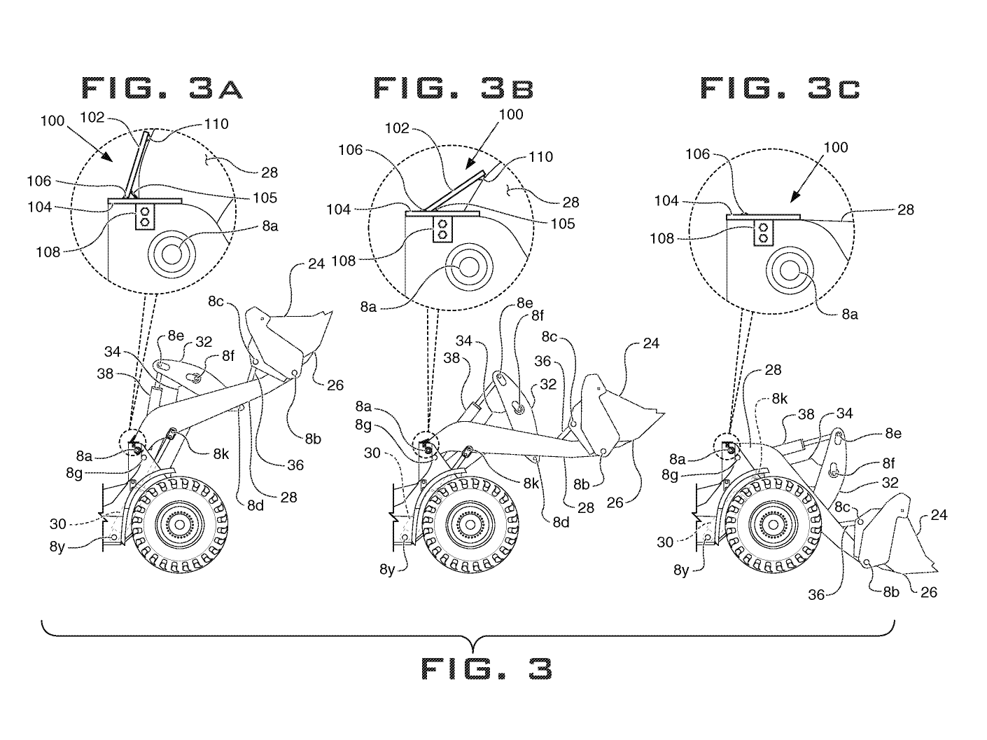

For a given position of the lift arms 28, the coupler 26 and bucket 24 are rotated toward the racked position by extending the tilt cylinder 38, and rotated in the opposite direction toward the dump position by retracting the tilt cylinder 38. The lift arms 28 may be connected to the front frame 14 by pivot pins 8a and to coupler 26 by pivot pins 8b. The tilt link 36 may be connected to coupler 26 by a pivot pin 8c and to the tilt lever 32 by an additional pivot pin 8d (FIG. 3). The tilt lever 32 may be connected to the tilt cylinder 38 by a pivot pin 8e and to the tilt lever support 34 by a pivot pin 8f. The opposite end of the tilt cylinder 38 may be connected to the front frame 14 by a pivot pin 8g. Lift cylinders 30 may be connected to lift arms 28 by pivot pins 8k and to the front frame 14 by pivot pins 8y. Because the pivot pins 8a, 8g, and 8y are attached to the front frame 14, the distance between the pivot pins 8a, 8g, and 8y is fixed. Although hinged service step assembly 100 is shown with lift arms 28 and Z-bar linkage assembly 31, the inventors contemplate use of hinged service step assembly 100 with other arrangements of lift arms 28 and Z-bar linkage assembly 31 providing similar functionality as having use in other machines in accordance with the present disclosure.

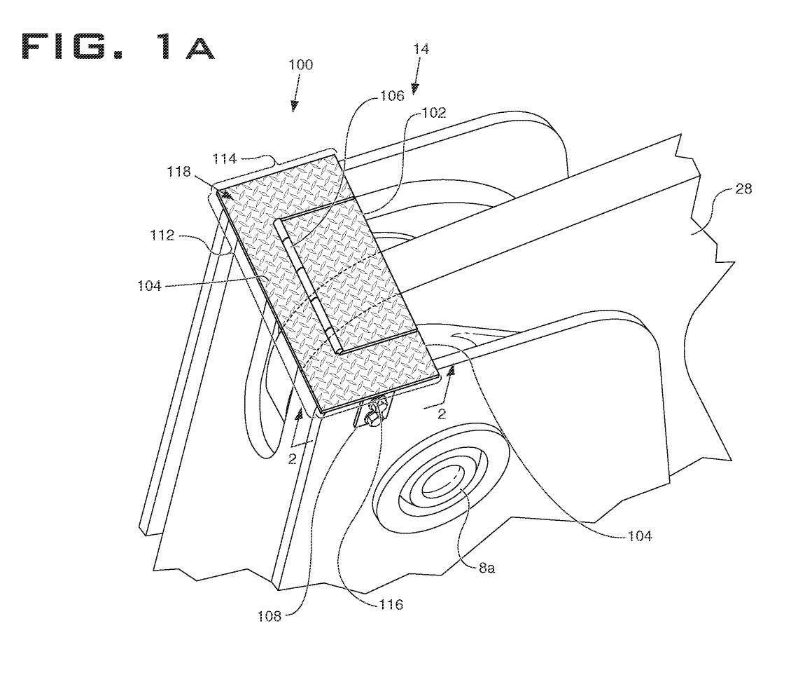

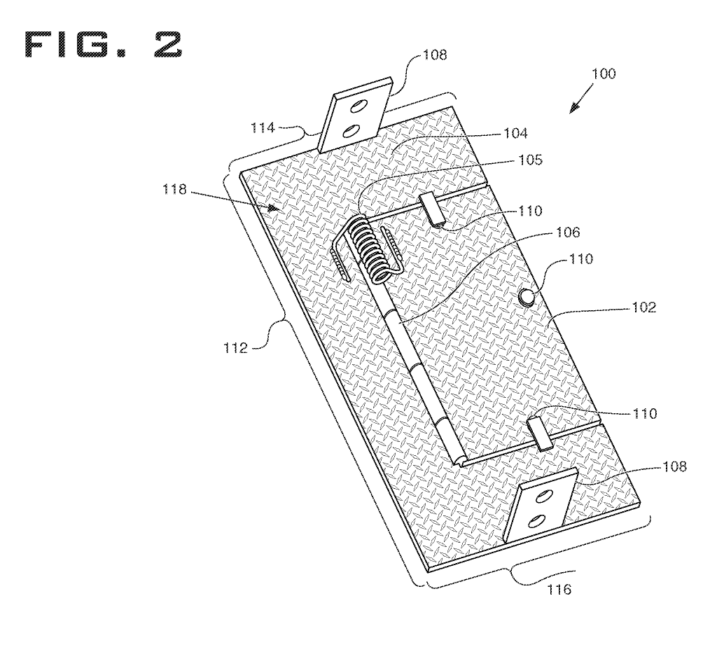

Having generally discussed an overview of wheel loader 10, embodiments of the hinged service step assembly 100 will now be discussed in more detail. FIG. 2 is a schematic view of a hinged service step assembly 100 in isolation and detached from wheel loader 10. As shown, hinged service step assembly 100 includes a first tread plate 102 and a second tread plate 104 having hinge 106, as well as attachment brackets 108. In some embodiments, the first tread plate 102 may be directly attached to lift arms 28 or other portions of machine 10 that would allow hinged service step assembly to function in the manner disclosed.

The first tread plate 102 and second tread plate 104 may include textured portions 118. Second tread plate 104 may include a first side portion 114, midsection 112, and second side portion 116. In some embodiments the first side portion 114 and second side portion 116 extend away from midsection 112 to form a C-channel that surrounds three sides of first tread plate 102. As shown, first side portion 114 and second side portion 116 extend away from midsection 112 in the same direction. In other embodiments, the C-channel design may vary to partially surround first tread plate 102. For example, the C-channel design may include curved portions or an oval design. In yet other embodiments, first tread plate 102 and second tread plate 104 may resemble a cylindrical, hexagon, decagon, parallelogram, pentagon, or any other shape that would be apparent to a person having ordinary skill in the art while allowing the first tread plate 102 to partially rotate about second tread plate 104.

Hinge 106 may include various types of bearings (not shown) to form a barrel hinge as well as various other types of hinges that would be apparent to a person having ordinary skill in the art. First tread plate 102, second tread plate 104, and attachment brackets 108 may be formed of a rigid material, such as steel, iron, or other high tensile strength metallic material. It is also contemplated that the first tread plate 102, second tread plate 104, and attachment brackets 108 may be formed of composite material, such as Kevlar, carbon graphite, or other high strength materials. In the alternative, first tread plate 102, second tread plate 104, and attachment brackets 108 may be formed of a rigid plastic material including a wide range of synthetic or semi-synthetic organic solids that are moldable.

First tread plate 102 moves with lift arms 28 during operation of wheel loader 10, as will be discussed in more detail below in reference is FIG. 3. Spring 105 allows the first tread plate 102 to stay in close proximity to lift arms 28. Spring 105 may include any variation of elastic objects configured to store mechanical energy as would be apparent to a person having ordinary skill in the art. During operation, wheel loader 10 experiences various amounts of vibrations and movement. To help compensate for the vibration between hinged service step assembly 100 and wheel loader 10, hinged service step assembly 100 may also include at least one bumper 110 that provides some level of shock absorption at various locations. Bumpers 110 may be formed of a soft or rigid plastic material including a wide range of synthetic or semi-synthetic organic solids that are moldable.

FIG. 3, including FIGS. 3a-3b, is a schematic view of a wheel loader 10 having lift arms 28 in first, second, and grounded positions within which one or more embodiments of the present disclosure may be implemented. A shown in FIGS. 3a-3c, the first tread plate 102 is capable of partially rotating around second tread plate 104 to allow lift arms 28 to experience a full range of motion from the first raised position in FIG. 3a, to the second raised position in FIG. 3b, and to the ground position in FIG. 3c. As previously mentioned, spring 105 allows the first tread plate 102 to stay in close proximity to lift arms 28. Second tread plate 104 may be attached to lift arms 28 with attachment brackets 108. The attachment brackets 108 may be welded or bolted into place after a position for mounting the hinged service step assembly 100 is located for access to the windshield portion 21. Hinged service step assembly 100 may also be attached by other means that would allow first tread plate 102 to partially rotate around second tread plate 104 as would be apparent to a person having ordinary skill in the art.

A method for retrofitting machine 10 having a lift arms 28 with hinged service step assembly 100 may include attaching the hinged service step assembly 100 to the lift arms 28. Attaching the hinged service step assembly 100 may include welding the hinged service step assembly 100 to the lift arms 28. Attaching the hinged service step assembly 100 may also include bolting the hinged service step assembly 100 to the lift arms 28. The method for retrofitting machine 10 may also include locating a position on the lift arms 28 for access to windshield portions 21.

Although the present disclosure discloses that the hinged service step assembly 100 is part of wheel loader 10, a person having ordinary skill in the art will appreciate that hinged service step assembly 100 may be beneficially implemented with other similar machines. Therefore, various combinations of the parts disclosed herein may be contemplated and such combinations can be implemented without deviating from the spirit of the present disclosure.

### INDUSTRIAL APPLICABILITY

The hinged service step assembly 100, for providing access to various sections of machine 10 such as windshield portions 21, of the present disclosure has applicability for implementation and use in industrial settings such as agriculture, construction, and the like with machines having Z-bar linkage assemblies 31 and/or lift arms 28 such as wheel loader 10.

The present disclosure provides a hinged service step assembly 100 for access to portions of wheel loader 10 such as windshield portions 21. The hinged service step assembly 100 allows moving parts of machine 10, such as the lift arms 28, full range of motion while still providing access when the moving part is in a stable location such as the grounded position shown in FIG. 3b. During operation of machine 10, an operator's vision is often partially impaired by mud or other debris that collects on the windshield portion 21. Similarly, an operator may need to access portions of machine 10 for maintenance items. In order to access portions of machine 10, the operator is tasked with determining a stable stepping location on the top portion 29 of lift arms 28. Alternatively, the operator may need to find a cleaning device with an extendable handle or another device to access unreachable portions of machine 10, thereby wasting valuable production time. Hinged service step assembly 100 provides a more stable platform and faster access for the operator to access the otherwise unreachable portions of machine 10. Accordingly, the present configuration of the hinged service step assembly 100 provides for increased production by reducing downtime. As a result, costs associated with operation of machine 10 can be less than that incurred with use of previously known systems. Moreover, the ability to remove mud and debris or access unreachable portions of machine 10 resulting from the present configuration allows manufactures of machines 10 to provide improved functionality with use of minimal components.

While aspects of the present disclosure have been particularly shown and described with reference to the embodiments above, it will be understood by those skilled in the art that various additional embodiments may be contemplated by modification of the disclosed machines, systems and methods without departing from the spirit and scope of what is disclosed. Such embodiments should be understood to fall within the scope of the present invention as determined based upon the claims below and any equivalents thereof.

What is claimed is:

1. A hinged service step assembly, comprising:
a first tread plate;
a second tread plate connected to the first tread plate with a hinge; and
an attachment bracket connected to the second tread plate, wherein the attachment bracket attaches to a machine having a lift arm.

2. The hinged service step assembly of claim 1, wherein the second tread plate comprises a midsection, a first side portion extending away from the midsection, and a second side portion extending away from the midsection in the same direction as the first side portion.

3. The hinged service step assembly of claim 2, wherein the first tread plate attaches to the midsection of the second tread plate, and wherein the first tread plate is capable of partially rotating around the midsection of the second tread plate.

4. The hinged service step assembly of claim 1, wherein the first tread plate includes at least one bumper.

5. The hinged service step assembly of claim 1, wherein the second tread plate includes at least one bumper.

6. The hinged service step assembly of claim 1, further comprising a spring attached to the first tread plate and the second tread plate.

7. The hinged service step assembly of claim 1, wherein the first tread plate and the second tread plate include a textured portion for traction.

8. A hinged service step assembly, comprising:
a first tread plate, comprising:
a midsection;
a first side portion extending away from the midsection; and
a second side portion extending away from the midsection in the same direction as the first side portion;
a second tread plate connected to the first tread plate with a hinge; and
an attachment bracket connected to the second tread plate, wherein the attachment bracket attaches to a wheel loader.

9. The hinged service step assembly of claim 8, wherein the first tread plate attaches to the midsection of the second tread plate, and wherein the first tread plate is capable of partially rotating around the midsection of the second tread plate.

10. The hinged service step assembly of claim 8, further comprising a spring attached to the midsection and the second tread plate.

11. The hinged service step assembly of claim 8, wherein the first tread plate includes at least one bumper.

12. The hinged service step assembly of claim 8, wherein the second tread plate includes at least one bumper.

13. The hinged service step assembly of claim 8, further comprising a spring attached to the first tread plate and the second tread plate.

14. The hinged service step assembly of claim 8, wherein the first tread plate and the second tread plate include a textured portion for traction.

15. The hinged service step assembly of claim 8, wherein the attachment bracket is welded to the wheel loader.

16. The hinged service step assembly of claim 8, wherein the attachment bracket is bolted to the wheel loader.

17. A method for retrofitting a machine having a lift arm with a hinged service step assembly, comprising:
attaching the hinged service step assembly to the lift arm, wherein the hinged service step assembly comprises:
a first tread plate;
a second tread plate connected to the first tread plate with a hinge; and
an attachment bracket connected to the second tread plate, wherein the attachment bracket attaches to the lift arm.

18. The method of claim 17, further comprising welding the hinged service step assembly to the lift arm.

19. The method of claim 17, further comprising bolting the hinged service step assembly to the lift arm.

20. The method of claim 17, further comprising locating a position on the lift arm for access to a portion of the machine.
